(19) United States
(12) Patent Application Publication
(10) Pub. No.: US 2005/0231499 A1
(43) Pub. Date: Oct. 20, 2005

(54) Light-emitting diode display device including a sensor unit

(75) Inventors: Tzuen-Yih Wang, Tao-Yuan Hsien (TW); Yan-Hsun Huang, Taipei City (TW)

Correspondence Address: MCNEES, WALLACE & NURICK LLC, 100 PINE STREET, P.O. BOX 1166, HARRISBURG, PA, 17108-1166, US

(73) Assignee: DYNASCAN TECHNOLOGY CORPORATION, Tao-Yuan Hsien (TW)

(21) Appl. No.: 10/922,738

(22) Filed: Aug. 20, 2004

(30) Foreign Application Priority Data
Apr. 16, 2004 (TW) 93110656

(51) Int. Cl. G09G 3/32

(52) U.S. Cl. 345/207

(57) ABSTRACT

A light-emitting diode display device includes a support unit, a display body that is mounted movably on the support unit, light-emitting diodes that are mounted on the display body, a drive unit that is coupled to the display body and that is capable of driving periodic movement of the display body relative to the support unit, a controller unit that is coupled to the light-emitting diodes and that is operable so as to actuate the light-emitting diodes for presenting images while the display body is driven by the drive unit to move relative to the support unit, and a photo-detector that is mounted on the display body, that generates an output signal in response to an incident light beam, and that is coupled to the controller unit such that the controller unit operates in accordance with the output signal generated by the photo-detector.

### BACKGROUND OF THE INVENTION

1. Field of the Invention

The invention relates to a light-emitting diode display device, more particularly to a light-emitting diode display device that includes a sensor unit that generates an output in response to an incident light beam.

2. Description of the Related Art

A conventional video game apparatus includes a display module that has a viewing surface for presenting images, a light-emitting module that generates a light beam and that simulates a gun, an image-capturing module that is focused on the viewing surface of the display module, and a controller module that is associated operably with the image-capturing module.

In operation, when a player aims the light-emitting module on the viewing surface, and pulls the trigger such that the light beam is incident upon the viewing surface, the image-capturing device captures the image on the viewing surface and the incident light beam, and generates a corresponding output signal. The controller module operates in accordance with the output signal generated by the image-capturing device. For example, in response to the output signal, the controller module determines whether the player hits a target, that is, when the light-beam is incident on a specified part of the image, and executes a predetermined operation.

Although the conventional video game apparatus achieves its intended purpose, since an image-capturing module is required during operation, additional costs are incurred. Moreover, the image-capturing module increases the size of the conventional video game apparatus. Further, the position at which the image-capturing module is disposed relative to the display module may affect the accuracy of the operation of the controller module.

### SUMMARY OF THE INVENTION

Therefore, the object of the present invention is to provide a light-emitting diode display device that is capable of overcoming the aforesaid drawbacks of the prior art.

According to the present invention, a light-emitting diode display device includes a support unit, a display body, a display panel, a drive unit, a controller unit, and a sensor unit.

The display body is mounted movably on the support unit and has a viewing surface. The display panel is mounted on the viewing surface of the display body and includes a plurality of light-emitting diodes. The drive unit is coupled to the display body and is capable of driving periodic movement of the display body relative to the support unit. The controller unit is coupled to the display panel and is operable so as to actuate the light-emitting diodes of the display panel for presenting images while the display body is driven by the drive unit to move relative to the support unit. The sensor unit is mounted on the display body and includes a photo-detector that generates an output signal in response to an incident light beam. The sensor unit is coupled to the controller unit such that the controller unit operates in accordance with the output signal generated by the sensor unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of the first preferred embodiment of a light-emitting diode display device according to the present invention;

FIG. 2 is a schematic circuit block diagram to illustrate a controller unit of the first preferred embodiment;

FIG. 3 is a schematic circuit block diagram to illustrate an amplifier, an analog-to-digital converter, a logic circuit, and a transmission circuit of the first preferred embodiment;

FIG. 4 is a schematic view of the second preferred embodiment of a light-emitting diode display device according to the present invention;

FIG. 5 is a fragmentary schematic view of a light-emitting diode display device modified from the second preferred embodiment;

FIG. 6 is a schematic view of the third preferred embodiment of a light-emitting diode display device according to the present invention; and

FIG. 7 is a schematic view of the fourth preferred embodiment of a light-emitting diode display device according to the present invention.

### DETAILED DESCRIPTION OF THE PREFERRED EMBODIMENTS

Before the present invention is described in greater detail, it should be noted that like elements are denoted by the same reference numerals throughout the disclosure.

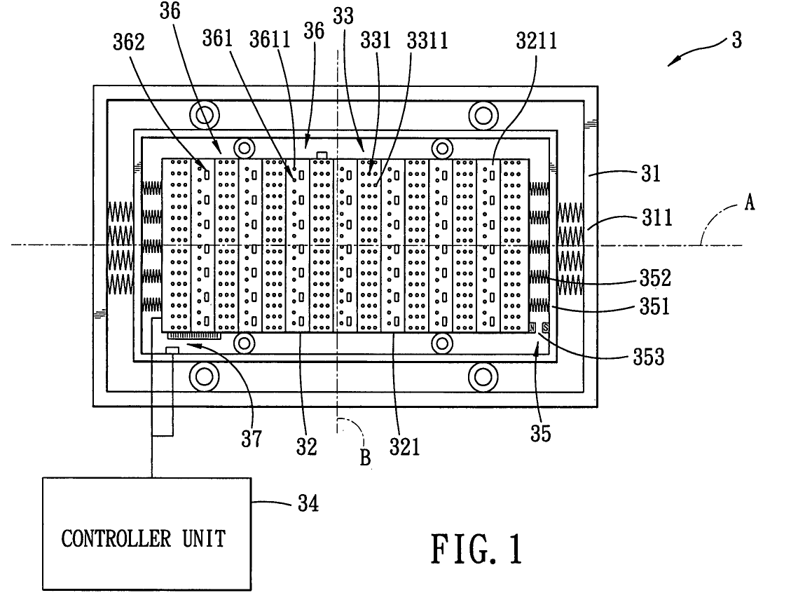

Referring to FIG. 1, the first preferred embodiment of a light-emitting diode display device 3 according to this invention is shown to include a support unit 31, a display body 32, a display panel 33, a drive unit 35, a controller unit 34, and a sensor unit 36.

In this embodiment, the support unit 31 includes a rectangular outer frame member 311.

The display body 32 is mounted movably on the outer frame member 311 of the support unit 31 and has a viewing surface 321. In this embodiment, the viewing surface 321 is generally rectangular, and has a longitudinal axis (A). It is noted herein that the viewing surface 321 of the display body 32 is divided into a plurality of sections 3211 along the longitudinal axis (A).

The display panel 33 is mounted on the viewing surface 321 of the display body 32, and includes sets of light-emitting diodes 331, each of which includes an array of light-emitting diodes 3311. In this embodiment, the display panel 33 is mounted on the viewing surface 321 of the display body 32 such that the sets of light-emitting diodes 331 are disposed spacedly along the longitudinal axis (A). The light-emitting diodes 3311 of each of the sets of light-emitting diodes 331 are disposed in a respective one of the sections 3211 of the viewing surface 321.

The drive unit 35 is coupled to the display body 32 and is capable of driving periodic movement of the display body 32 relative to the support unit 31. In this embodiment, the drive unit 35 drives the display body 32 to reciprocate back and forth along the longitudinal axis (A) relative to the support unit 31. In particular, the drive unit 35 includes an inner frame member 351, biasing means 352, and module moving means 353. The inner frame member 351 is disposed to confine the display body 32 therein and has a size sufficient to permit movement of the display body 32 in opposite directions of the longitudinal axis (A). The biasing means 352 is disposed between the inner frame member 351 and the display body 32, and provides a biasing force to the display body 32 in the opposite directions of the longitudinal axis (A). The module moving means 353 is disposed between the inner frame member 351 and the display body 32, and provides a moving force to move the display body 32 in the opposite directions of the longitudinal axis (A). The outer frame member 311 of the support unit 31 is disposed to confine the inner frame member 351 movably therein and has a size sufficient to permit movement of the inner frame member 351 in the opposite directions of the longitudinal axis (A). Since the feature of this invention does not reside in the specific configuration of the drive unit 35, a detailed description thereof is omitted herein for the sake of brevity. For additional information on the drive unit 35, one may refer to U.S. Pat. No. 6,348,905.

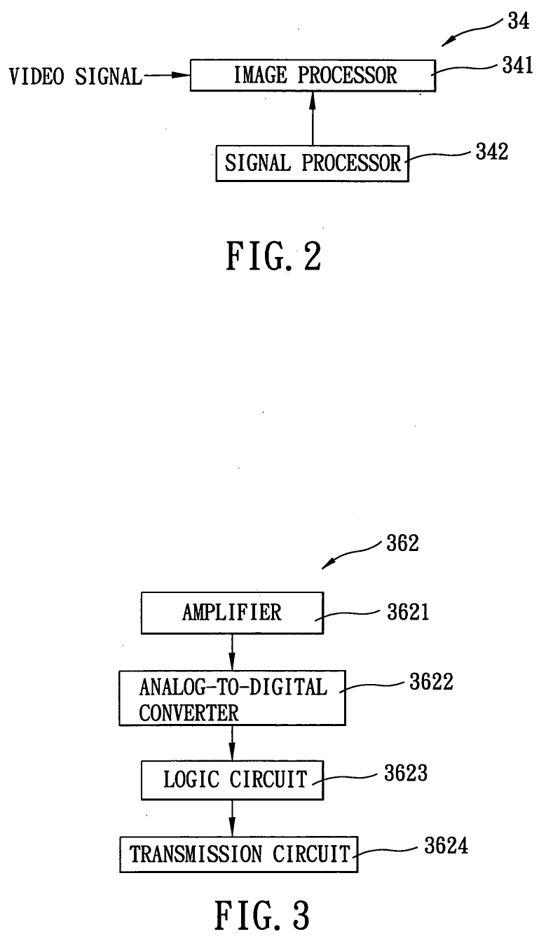

With further reference to FIG. 2, the controller unit 34 is coupled to the display panel 33, and includes an image processor 341 that receives a video signal, and that is operable so as to actuate the light-emitting diodes 3311 of the sets of light-emitting diodes 331 of the display panel 33 for presenting images while the display body 32 is driven by the drive unit 35 to move relative to the support unit 31, in a manner that will be described hereinafter.

The sensor unit 36 is mounted on the viewing surface 321 of the display body 32, and includes sets of photo-detectors 361, each of which includes an array of photo-detectors 3611. Each of the photo-detectors 3611 generates an output signal in response to an incident light beam. Preferably, each of the photo-detectors 3611 is a photo-diode. In this embodiment, the sensor unit 36 is mounted on the viewing surface 321 of the display body 32 such that the sets of photo-detectors 361 are disposed spacedly along the longitudinal axis (A). The photo-detectors 3611 of each of the sets of photo-detectors 361 are disposed in a respective one of the sections 3211 of the viewing surface 321.

It is noted herein that the sets of the light-emitting diodes 331 of the display panel 33 and the sets of photo-detectors 361 of the sensor unit 36 are mounted on the viewing surface 321 at non-overlapping positions.

The sensor unit 36 is coupled to the controller unit 34 such that the controller unit 34 operates in accordance with the output signals generated by the photo-detectors 3611 of the sensor unit 36. In this embodiment, the controller unit 34 further includes a signal processor 342 coupled to the image processor 341.

The light-emitting diode display device 3 further includes an encoder 37 that is mounted on the support unit 31, that is coupled to the controller unit 34, and that generates first co-ordinate signals. In this embodiment, the encoder 37 is a linear encoder. The first co-ordinate signals indicate the positions of the photo-detectors 3611, which generated the output signals, relative to the longitudinal axis (A) while the display body 32 is driven by the drive unit 35 to move relative to the support unit 31. Since the feature of the present invention does not reside in the specific configuration of the encoder 37, which is conventional in construction, a detailed description of the same is omitted herein for the sake of brevity.

The sensor unit 36 further includes a plurality of signal processing units 362, each of which corresponds to respective ones of the photo-detectors 3611 and is operable so as to process the output signals generated by the respective ones of the photo-detectors 3611 prior to receipt by the signal processor 342 of the controller unit 34. In particular, with further reference to FIG. 3, each of the signal processing units 362 includes an amplifier 3621 coupled to the respective one of the photo-detectors 3611, an analog-to-digital converter 3622 coupled to a respective one of the amplifiers 3621, a logic circuit 3623 coupled to a respective one of the analog-to-digital converters 3622, and a transmission circuit 3624 coupled to a respective one of the logic circuits 3623, and the signal processor 342 of the controller unit 34. Each of the amplifiers 3621 amplifies the output signal of a respective one of the photo-detectors 3611 at a predetermined gain. Each of the analog-to-digital converters 3622 converts a respective one of the amplified output signals into a respective one of digital signals. Each of the logic circuits 3623 determines appropriate time sequences to send the respective one of the digital signals to the signal processor 342 through the respective one of the transmission circuits 3624. In response to the digital signals, the signal processor 342 generates second co-ordinate signals. The second co-ordinate signals indicate the positions of the photo-detectors 3611, which generated the output signals, relative to an axis (B) transverse to the longitudinal axis (A) while the display body 32 is driven by the drive unit 35 to move relative to the support unit 31. In response to the first and second co-ordinate signals, the signal processor 342 of the controller unit 34 executes a predetermined operation.

For example, in an arcade shooting game, a part of the image on the viewing surface 321 of the display body 32 serves as a target. When a player aims a light-emitting instrument (not shown), which simulates a gun, pulls the trigger, and hits the target such that a light beam generated by the light-emitting instrument is incident on the part of the image, appropriate ones of the photo-detectors 3611 generate output signals. In response to the output signals, the signal processor 342 of the controller unit 34 generates the second co-ordinate signals. At this time, the encoder 37 generates the first co-ordinate signals. The signal processor 342 of the controller unit 34, based on the first and second co-ordinate signals, determines the relationship between the photo-detectors 3611, which generated the output signals, and the image presented on the viewing surface 321 of the display body 32. Accordingly, the signal processor 342 of the controller unit 34 executes a predetermined operation such that the image processor 341 of the controller unit 34 actuates the light-emitting diodes 3311 so as to display a simulated score board on the display panel 33 while the display body 32 is driven by the drive unit 35 to move relative to the support unit 31.

From the above description, by virtue of persistence of vision, when the drive unit 35 drives the display body 32 to reciprocate back and forth along the longitudinal axis (A) relative to the support unit 31 at a corresponding frequency, and when the image processor 341 of the controller unit 34 actuates the light-emitting diodes 3311 of each of the sets of light-emitting diode 331 at different spatial positions, images are presented on the viewing surface 321 of the display body 32. As such, the required number of light-emitting diodes 3311 for image presentation can be significantly decreased. The same principle is applied to decrease the required number of photo-detectors 3611 for light-beam detection.

It is noted herein that, although each of the photo-detectors 3611 of each of the sets of photo-detectors 361 is exemplified using a photo-diode, it should be apparent to those skilled in the art that a photo-resistor, a photo-transistor, or an infrared sensor may be used as well.

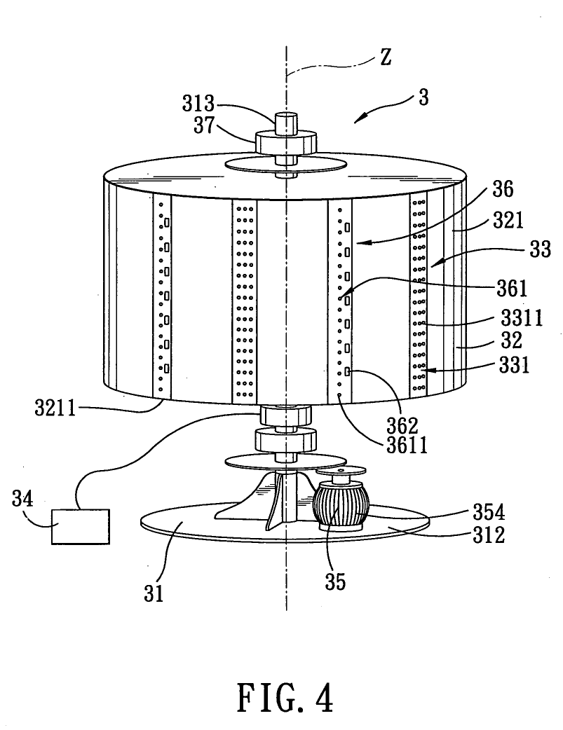

Referring to FIG. 4, in the second preferred embodiment of a light-emitting diode display device 3 according to this invention, the viewing surface 321 is generally cylindrical, and has an axis (Z). The axis (Z) is also the axis of rotation of the display body 32 relative to the support unit 31.

The display panel 33 is mounted on the viewing surface 321 of the display body 32 such that the sets of light-emitting diodes 331 are disposed spacedly with respect to the axis (Z).

The sensor unit 36 is mounted on the viewing surface 321 of the display body 32 such the sets of photo-detectors 361 are disposed spacedly with respect to the axis (Z).

The support unit 31 includes a base plate 312, and a shaft 313 mounted on the base plate 312. The display body 32 is mounted rotatably on the shaft 313.

The drive unit 35 includes a motor 354 that drives the display body 32 to rotate relative to the support unit 31 about the axis (Z).

The encoder 37 is an angular encoder. The first co-ordinate signals indicate the angular positions of the photo-detectors 3611, which generated the output signals, relative to the axis (Z) while the display body 32 is driven by the drive unit 35 to rotate relative to the support unit 31. Since the feature of the present invention does not reside in the specific configuration of the encoder 37, which is conventional in construction, a detailed description of the same is omitted herein for the sake of brevity.

The second co-ordinate signals indicate the axial positions of the photo-detectors 3611, which generated the output signals, relative to the axis (Z) while the display body 32 is driven by the drive unit 35 to move relative to the support unit 31.

As in the previous embodiment, by virtue of persistence of vision, when the drive unit 35 drives rotation of the display body 32 about the axis (Z) relative to the support unit 31 at a corresponding rotational speed, and when the image processor 341 of the controller unit 34 actuates the light-emitting diodes 3311 of each of the sets of light-emitting diodes 331 at different spatial positions, images are presented on the viewing surface 321 of the display body 32. As such, the required number of light-emitting diodes 3311 for image presentation can be decreased significantly. U.S. Pat. No. 6,335,714 discloses a display apparatus that employs substantially the same operating principle to present images. Likewise, the same principle is applied to decrease the required number of photo-detectors 3611 for light beam detection.

Frame rate and image resolution are two primary measures of image quality. For instance, televisions display sixty frames per second. In order to achieve a frame rate of at least sixty frames per second, the light-emitting diodes 3311 and the rotational speed of the display body 32 would have to meet certain conditions. For the present invention, the frame rate is the product of the number of sets of light-emitting diodes 331 and the rotational speed of the display body 32. Thus, if there were twelve sets of light-emitting diodes 331, the rotational speed of the display body 32 would have to be five revolutions or more per second. Moreover, in order to achieve an image resolution of at least four hundred thousand pixels, the number of light-emitting diodes 3311 of each of the sets of light-emitting diodes 331 and the pulse-per-revolution of the encoder 37 would have to meet certain conditions. For the present invention, the image resolution is the product of the number of light-emitting diodes 3311 of each of the sets of light-emitting diodes 331 and the pulse-per-revolution of the encoder 37. Thus, if the encoder 37 has 2000 pulses per revolution, the number of light-emitting diodes 3311 of each of the sets of light-emitting diodes 331 would have to be two hundred or more. From the foregoing, even if there was only one photo-detector 3611, by rotating the display body 32 at a corresponding rotational speed, it is possible to achieve the same effect.

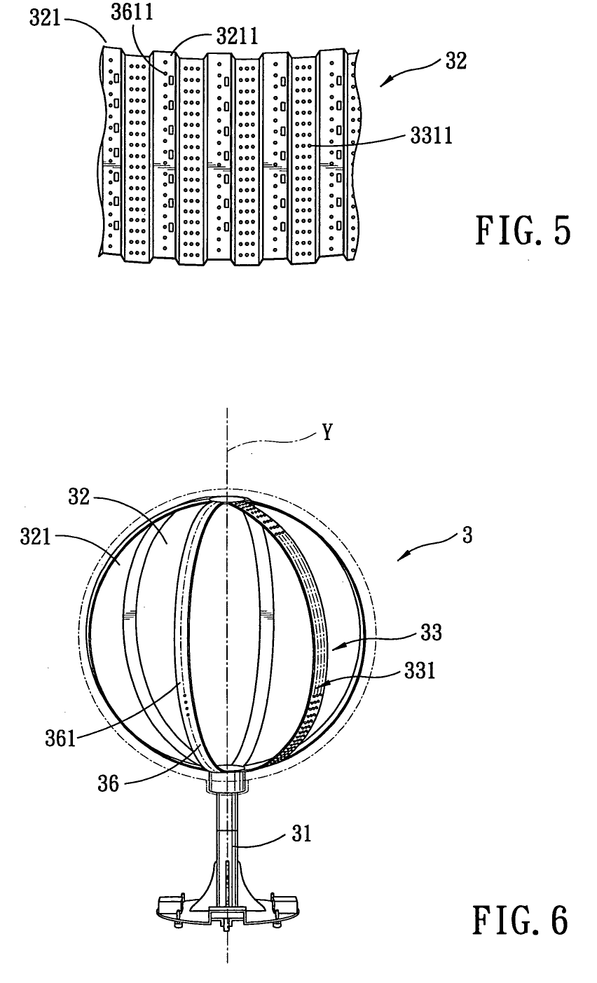

In an alternative embodiment, as shown in FIG. 5, the sections 3211 of the viewing surface 321 of the display body 32 mounted with the photo-detectors 3611 may be disposed to project relative to those mounted with the light-emitting diodes 3311.

Referring to FIG. 6, in a third preferred embodiment of a light-emitting diode display device 3 according to this invention, the viewing surface 321 is generally spherical, and has an axis (Y). The axis (Y) is also the axis of rotation of the display body 32 relative to the support unit 31.

The drive unit (not shown) drives the display body 32 to rotate relative to the support unit 31 about the axis (Y).

The display pane 133 is mounted on the viewing surface 321 of the display body 32 such that the sets of light-emitting diodes 331 are disposed spacedly with respect to the axis (Y).

The sensor unit 36 is mounted on the viewing surface 321 of the display body 32 such that the sets of photo-detectors 361 are disposed spacedly with respect to the axis (Y).

The first co-ordinate signals indicate the angular positions of the photo-detectors 3611, which generated the output signals, relative to the axis (Y) while the display body 32 is driven by the drive unit 35 to rotate relative to the support unit 31.

The second co-ordinate signals indicate the axial positions of the photo-detectors 3611, which generated the output signals, relative to the axis (Y) while the display body 32 is driven by the drive unit 35 to move relative to the support unit 31.

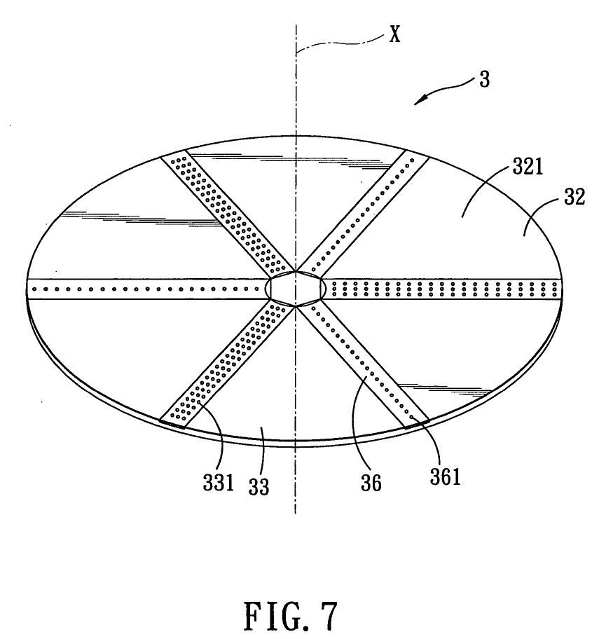

Referring to FIG. 7, in a fourth preferred embodiment of a light-emitting diode display device 3 according to this invention, the viewing surface 321 is generally circular, and has an axis (X). The axis (X) is likewise the axis of rotation of the display body 32 relative to the support unit (not shown).

The drive unit (not shown) drives the display body 32 to rotate relative to the support unit about the axis (X).

The display panel 33 is mounted on the viewing surface 321 of the display body 32 such that the sets of light-emitting diodes 331 extend radially from the axis (X) and are disposed spacedly with respect to the axis (X).

The sensor unit 36 is mounted on the viewing surface 321 of the display body 32 such that the sets of photo-detectors 361 extend radially from the axis (X) and are disposed spacedly with respect to the axis (X).

The first co-ordinate signals indicate the angular positions of the photo-detectors 3611, which generated the output signals, relative to the axis (X) while the display body 32 is driven by the drive unit 35 to rotate relative to the support unit 31.

The second co-ordinate signals indicate the radial positions of the photo-detectors 3611, which generated the output signals, relative to the axis (X) while the display body 32 is driven by the drive unit 35 to move relative to the support unit 31.

It has thus been shown that the light-emitting diode display device 3 of this invention includes a support unit 31, a display body 32 mounted movably on the support unit 31, a display panel 33 that includes sets of light-emitting diodes 331, each of which includes light-emitting diodes 3311, mounted on the display body 32, a drive unit 35 coupled to the display body 32 and capable of driving periodic movement of the display body 32 relative to the support unit 31, a controller unit 34 coupled to the display panel 33 and operable so as to actuate the light-emitting diodes 3311 for presenting images while the display body 32 is driven by the drive unit 35 to move relative to the support unit 31, and a sensor unit 36 that includes sets of photo-detectors 361, each of which includes photo-detectors 3611 that generate an output signal in response to an incident light beam, that is mounted on the display body 32, and that is coupled to the controller unit 34 such that the controller unit 34 operates in accordance with the output signals generated by the photo-detectors 3611.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A light-emitting diode display device comprising:
a support unit;
a display body mounted movably on said support unit and having a viewing surface;
a display panel mounted on said viewing surface of said display body and including a plurality of light-emitting diodes;
a drive unit coupled to said display body and capable of driving periodic movement of said display body relative to said support unit;
a controller unit coupled to said display panel and operable so as to actuate said light-emitting diodes of said display panel for presenting images while said display body is driven by said drive unit to move relative to said support unit; and
a sensor unit mounted on said display body and including a photo-detector that generates an output signal in response to an incident light beam, said sensor unit being coupled to said controller unit such that said controller unit operates in accordance with the output signal generated by said sensor unit.

2. The light-emitting diode display device as claimed in claim 1, wherein said photo-detector is one of a photo-diode, a photo-resistor, a photo-transistor and an infrared sensor.

3. The light-emitting diode display device as claimed in claim 1, wherein said viewing surface is generally rectangular, and has a longitudinal axis.

4. The light-emitting diode display device as claimed in claim 3, wherein said drive unit drives said display body to reciprocate back and forth along the longitudinal axis relative to said support unit.

5. The light-emitting diode display device as claimed in claim 4, wherein said display panel and said sensor unit are mounted on said viewing surface at non-overlapping positions.

6. The light-emitting diode display device as claimed in claim 1, wherein said viewing surface is generally cylindrical, and has an axis.

7. The light-emitting diode display device as claimed in claim 6, wherein said drive unit drives said display body to rotate relative to said support unit about said axis.

8. The light-emitting diode display device as claimed in claim 7, wherein said display panel and said sensor unit are mounted on said viewing surface at non-overlapping positions.

9. The light-emitting diode display device as claimed in claim 1, wherein said viewing surface is generally spherical.

10. The light-emitting diode display device as claimed in claim 9, wherein said drive unit drives said display body to rotate relative to said support unit about an axis.

11. The light-emitting diode display device as claimed in claim 10, wherein said display panel and said sensor unit are mounted on said viewing surface at non-overlapping positions.

12. The light-emitting diode display device as claimed in claim 1, wherein said viewing surface is generally circular.

13. The light-emitting diode display device as claimed in claim 12, wherein said drive unit drives said display body to rotate relative to said support unit about an axis.

14. The light-emitting diode display device as claimed in claim 13, wherein said display panel and said sensor unit are mounted on said viewing surface at non-overlapping positions.

15. The light-emitting diode display device as claimed in claim 1, further comprising an encoder coupled to said controller unit and capable of determining spatial positions of said light-emitting diodes and said photo-detector with respect to a reference position while said display body is driven by said drive unit to move relative to said support unit.
